(19) United States
(12) Patent Application Publication
(10) Pub. No.: US 2023/0056947 A1
(43) Pub. Date: Feb. 23, 2023

(54) LEARNING APPARATUS, METHOD, AND STORAGE MEDIUM

(71) Applicant: KABUSHIKI KAISHA TOSHIBA, Tokyo (JP)

(72) Inventors: Shuhei NITTA, Tokyo (JP); Yasutaka Furusho, Fuchu (JP); Albert Rodriguez Mulet, Kawasaki (JP); Atsushi Yaguchi, Tokyo (JP); Akiyuki TANIZAWA, Kawasaki (JP)

(73) Assignee: KABUSHIKI KAISHA TOSHIBA, Tokyo (JP)

(21) Appl. No.: 17/652,805

(22) Filed: Feb. 28, 2022

(30) Foreign Application Priority Data
Aug. 18, 2021 (JP) 2021-133392

(51) Int. Cl. G06N 3/08; G06N 3/04

(52) U.S. Cl. CPC G06N 3/08; G06N 3/0454

(57) ABSTRACT

According to one embodiment, a learning apparatus includes a processing circuit. The processing circuit acquires a first training condition and a first model trained in accordance with the first training condition, sets a second training condition used to reduce a model size of the first model, different from the first training condition, in accordance with the second training condition and based on the first model, trains a second model whose model size is smaller than that of the first model, and in accordance with a third training condition that is not the same as the second training condition and complies with the first training condition, trains a third model based on the second model.

### CROSS-REFERENCE TO RELATED APPLICATIONS

This application is based upon and claims the benefit of priority from Japanese Patent Application No. 2021-133392, filed Aug. 18, 2021, the entire contents of which are incorporated herein by reference.

### FIELD

Embodiments described herein relate generally to a learning apparatus, a method, and a storage medium.

### BACKGROUND

In a technique described in patent literature 1 (Jpn. Pat. Appln. KOKAI Publication No. 2019-164839), the inference accuracy of a neural network trained under a plurality of training conditions and a model size are displayed as graphs, thereby facilitating confirmation of tradeoff between the inference accuracy and the model size.

However, in the technique according to patent literature 1, it is sometimes impossible to satisfy desired performance (for example, an inference accuracy A or more and a model size B or less) because of the tradeoff between the inference accuracy and the model size. In this case, to further adjust the training conditions and execute retraining, professional skills and experiences of high level are required, and works of confirmation and operations for these are cumbersome.

### BRIEF DESCRIPTION OF THE DRAWINGS

FIG. 1 is a block diagram showing an example of the configuration of a learning apparatus according to the embodiment;

FIG. 2 is a flowchart showing the procedure of a training processing example by the learning apparatus according to the embodiment;

FIG. 3 is a view schematically showing an example of the configuration of a first machine learning model;

FIG. 4 is a view schematically showing second machine learning models before and after compacting;

FIG. 5 is a view showing an example of a display screen of a training result when it is determined in step S4 of FIG. 2 that retraining is unnecessary;

FIG. 6 is a view showing an example of a display screen of a training result when it is determined in step S4 of FIG. 2 that retraining is necessary; and

FIG. 7 is a view showing an example of a display screen of the architecture of a machine learning model.

### DETAILED DESCRIPTION

A learning apparatus according to the embodiment includes a processing circuit. The processing circuit acquires a first training condition and a first machine learning model trained in accordance with the first training condition. The processing circuit sets a second training condition used to reduce a model size of the first machine learning model, different from the first training condition. In accordance with the second training condition and based on the first machine learning model, the processing circuit trains a second machine learning model whose model size is smaller than that of the first machine learning model. In accordance with a third training condition that is not the same as the second training condition and complies with the first training condition, the processing circuit trains a third machine learning model based on the second machine learning model.

A learning apparatus, a method, and a storage medium according to this embodiment will now be described with reference to the accompanying drawings.

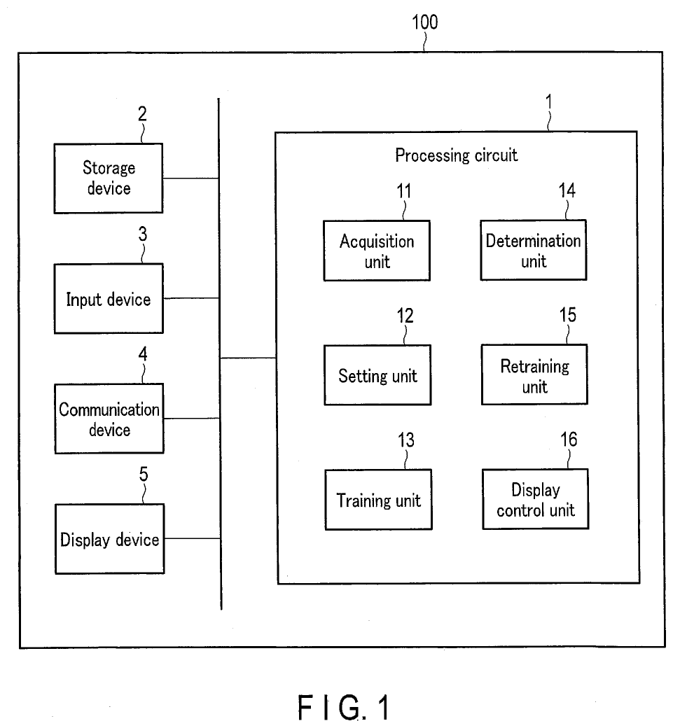

FIG. 1 is a block diagram showing an example of the configuration of a learning apparatus 100 according to this embodiment. As shown in FIG. 1, the learning apparatus 100 is a computer including a processing circuit 1, a storage device 2, an input device 3, a communication device 4, and a display device 5. Data communication between the processing circuit 1, the storage device 2, the input device 3, the communication device 4, and the display device 5 is performed vi a bus.

The processing circuit 1 includes a processor such as a CPU (Central Processing Unit), and a memory such as a RAM (Random Access Memory). The processing circuit 1 includes an acquisition unit 11, a setting unit 12, a training unit 13, a determination unit 14, a retraining unit 15, and a display control unit 16. The processing circuit 1 executes a learning program of a machine learning model, thereby implementing the functions of the units 11 to 16. The learning program is stored in a non-transitory computer-readable storage medium such as the storage device 2. The learning program may be implemented as a single program that describes all the functions of the units 11 to 16, or may be implemented as a plurality of modules divided into several functional units. In addition, the units 11 to 16 may be implemented by an integrated circuit such as an ASIC (Application Specific Integrated Circuit). In this case, the units may be implemented on a single integrated circuit, or may be individually implemented on a plurality of integrated circuits.

The acquisition unit 11 acquires various kinds of data. For example, the acquisition unit 11 acquires a first training condition and a first machine learning model. The first training condition is a training condition concerning the first machine learning model, and is a training condition that focuses on the accuracy of inference. The first machine learning model is a machine learning model trained in accordance with the first training condition. As the machine learning model, a neural network is used. Also, the acquisition unit 11 acquires training data and a first inference accuracy. The training data is training data used to train the first machine learning model. The first inference accuracy is a value representing the accuracy of inference of the first machine learning model.

The setting unit 12 sets a second training condition that is a training condition different from the first training condition and is used to reduce (compact) the model size of the first machine learning model. The setting unit 12 may set the second training condition based on the first training condition, or may set the second training condition independently of the first training condition.

In accordance with the second training condition and based on the first machine learning model, the training unit 13 trains a second machine learning model whose model size is smaller than that of the first machine learning model. In addition, the training unit 13 calculates a second inference accuracy representing the accuracy of inference concerning the second machine learning model.

The determination unit 14 determines the necessity of training of a third machine learning model based on comparison between the first inference accuracy representing the accuracy of inference concerning the first machine learning model and the second inference accuracy representing the accuracy of inference concerning the second machine learning model.

In accordance with a third training condition that is not the same as the second training condition and complies with the first training condition, the retraining unit 15 trains a third machine learning model based on the second machine learning model. In addition, the retraining unit 15 calculates a third inference accuracy representing the accuracy of inference concerning the trained third machine learning model. The third training condition is a training condition that focuses on the accuracy of inference as compared to the second training condition. The third machine learning model has the same model architecture as the second machine learning model or a model architecture deformed from that of the second machine learning model. As an example, the third machine learning model is trained in accordance with the third training condition that is the same as the first training condition, and has an inference accuracy higher than that of the second machine learning model.

The display control unit 16 displays various kinds of information such as a training result on the display device 5. As an example, the display control unit 16 displays the architectures of the first machine learning model, the second machine learning model, and/or the third machine learning model. As another example, the display control unit 16 displays the model sizes of the first machine learning model, the second machine learning model, and/or the third machine learning model. As still another example, the display control unit 16 displays the performance of the first machine learning model, the second machine learning model, and/or the third machine learning model.

The storage device 2 is formed by a ROM (Read Only Memory), an HDD (Hard Disk Drive), an SSD (Solid State Drive), an integrated circuit storage device, or the like. The storage device 2 stores learning programs, various kinds of data, and the like.

The input device 3 inputs various kinds of instructions from an operator. As the input device 3, a keyboard, a mouse, various kinds of switches, a touch pad, a touch panel display, and the like can be used. An output signal from the input device 3 is supplied to the processing circuit 1. Note that the input device 3 may be an input device of a computer connected to the processing circuit 1 by a cable or wirelessly.

The communication device 4 is an interface configured to perform data communication with an external device connected to the learning apparatus 100 via a network.

The display device 5 displays various kinds of information under the control of the display control unit 16. As the display device 5, a CRT (Cathode-Ray Tube) display, a liquid crystal display, an organic EL (Electro Luminescence) display, an LED (Light-Emitting Diode) display, a plasma display, or another arbitrary display known in the technical field can appropriately be used. Also, the display device 5 may be a projector.

An example of the operation of the learning apparatus 100 will be described below in detail.

In the following embodiment, training data is an image, and a machine learning model is a neural network configured to execute an image classification task for classifying an image in accordance with a target drawn in an image. The image classification task according to the following embodiment is assumed to be 2-class image classification for classifying an image to one of “dog” and “cat” as an example.

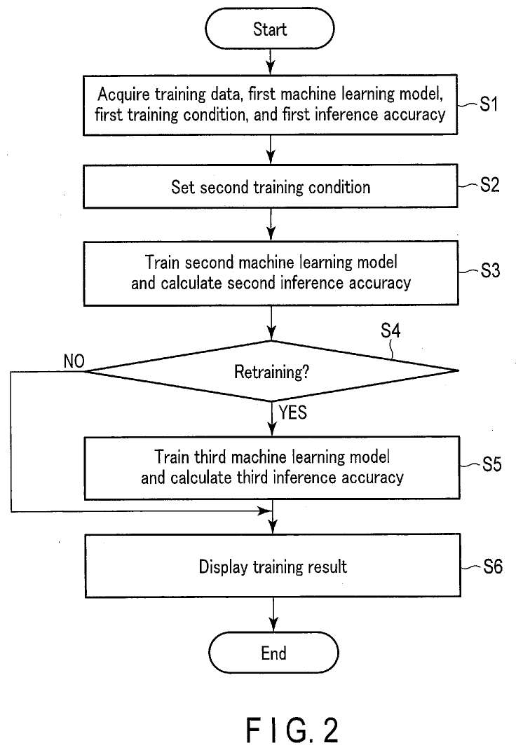

FIG. 2 is a flowchart showing the procedure of a training processing example by the learning apparatus 100 according to this embodiment. The processing circuit 1 reads out a learning program from the storage device 2, and operates in accordance with the learning program, thereby executing training processing shown in FIG. 2. The training processing is training processing of a machine learning model capable of easily obtaining desired performance.

In this embodiment, the machine learning model includes a model architecture and learning parameters. The model architecture is a factor decided by hyper parameters such as the type of a neural network, the number of layers, the number of nodes, and the number of channels. A node is recognized when the neural network is an MLP (Multilayer Perceptron), and a channel is recognized when the neural network is a CNN (Convolutional Neural Network). The neural network according to this embodiment can be applied to any structure and is assumed to be an MLP hereinafter. The learning parameters are parameters set in the machine learning model, and are, in particular, parameters as the training target. More specifically, the learning parameters are parameters such as a weight parameter and a bias.

The performance of the machine learning model according to this embodiment is defined by the combination of an inference accuracy and a model size. The inference accuracy is the accuracy of inference of the machine learning model, as described above, and if the task of the machine learning model is image classification, for example, a recognition ratio is used. The model size is an index concerning the size or calculation load of the machine learning model. Factors of the model size are the number of learning parameters, the number of hidden layers, the number of nodes or the number of channels of each hidden layer, a number of multiplications in the inference, power consumption, and the like.

As shown in FIG. 2, first, the acquisition unit 11 acquires training data, the first machine learning model, the first training condition, and the first inference accuracy (step S1). The acquisition unit 11 may acquire these data from another computer via the communication device 4, or may acquire these from the storage device 2.

The training data is data used for training of the machine learning model, and includes a plurality of training samples. Each training sample includes an input image xᵢ and a target label tᵢ corresponding to the input image xᵢ. “i” takes values of 1, 2, . . . , N, and represents the serial number of a training sample. “N” represents the number of training samples. The input image xᵢ is a pixel set with a horizontal width H and a vertical width V, and can be expressed as a (H×V)-dimensional vector. The target label tᵢ is a vector having dimensions as many as classes. In this embodiment, the target label tᵢ is a two-dimensional vector including an element corresponding to class “dog” and an element corresponding to class “cat”. Each element takes “1” if a target corresponding to the element is drawn in the input image xᵢ, and takes “0” if a target other than that is drawn. For example, if “dog” is drawn in the input image xᵢ, the target label tᵢ is represented by (1, 0)^{T}.

The machine learning model according to this embodiment is defined by a model architecture and learning parameters. The model architecture is a factor decided by hyper parameters such as the type of a neural network, the type of each layer, the connection relationship between layers, the number of layers, and the number of nodes. The learning parameters are the target of training, and are parameters such as a weight parameter and a bias.

The first machine learning model is a machine learning model before compacting. The first machine learning model is a machine learning model trained by the learning apparatus 100 or another computer.

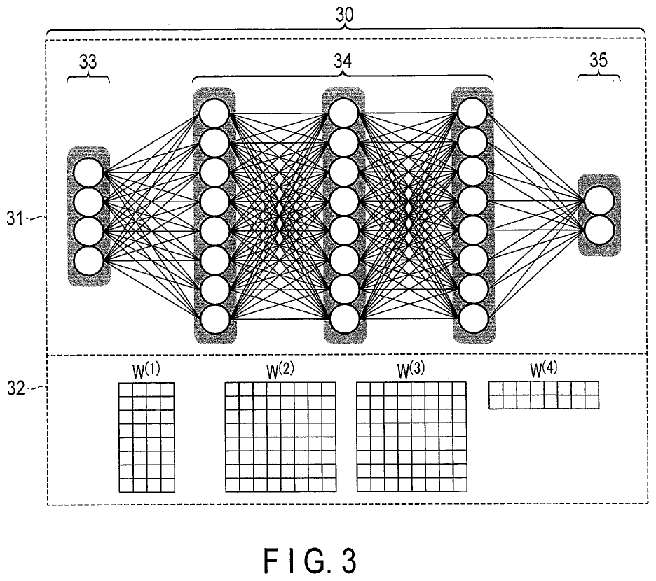

FIG. 3 is a view schematically showing an example of the configuration of a first machine learning model 30. As shown in FIG. 3, the first machine learning model 30 is formed by a first model architecture 31 and a first learning parameter 32. The first model architecture 31 includes an input layer 33, a hidden layer 34, and an output layer 35. The input layer 33 inputs an input image of a four-dimensional vector with H=2, and V=2. The hidden layer 34 is a fully connected layer in which the number of nodes=8, and the number of layers=3. The output layer 35 outputs the estimated probability value of each of dog and cat. The first learning parameter 32 includes weight parameters and biases concerning conversion between layers. In FIG. 3, notations concerning the bias are omitted for the sake of simplicity. A weight parameter is represented by a matrix W={W⁽¹⁾} (1=1, 2, 3, 4=L). In this embodiment, the sizes (the number of weight parameters) of the matrices W⁽¹⁾ are 32, 64, 64, and 16, and the total number of weight parameters is 176. In FIG. 3, each weight parameter is expressed as a white square.

The first training condition is a training condition for the machine learning model before compacting, and is a training condition that focuses on the inference accuracy. As the training condition, as an example, the type of an activation function, the type of an optimizer (optimization method), an L2 regularization intensity, an epoch number, and a mini batch size are set. As an example, the first training condition is set to an activation function type “Leaky ReLU”, an optimizer type “Momentum SGD (learning ratio α=0.1)”, an L2 regularization intensity “λ=0”, an epoch number “100”, and a mini batch size “128”. Note that the type of the training condition is not limited to the above-described type.

The first inference accuracy means the inference accuracy of the trained first machine learning model obtained by training the first machine learning model in accordance with the first training condition. In this embodiment, the first inference accuracy is a recognition ratio obtained when inference is performed by the trained first machine learning model using evaluation data different from training data. As an example, the first inference accuracy is assumed to be 95%.

When step S1 is performed, the setting unit 12 sets the second training condition (step S2). The second training condition is a training condition for compacting learning, different from the first training condition. As the second training condition, the setting unit 12 changes at least one of the optimizer type, the regularization type, and the regularization intensity from the first training condition. In this embodiment, a technique described in US 2020/0012945 is used as a compacting learning method. In this technique, the optimizer is set to Adam, and the activation function is set to a saturation nonlinear function like ReLU. Learning is performed with weight decay, thereby performing learning such that weight parameters connected to some nodes automatically become zero, and consequently reducing the model size of the neural network.

The setting unit 12 according to this embodiment changes items in the first training condition, which are needed to apply the compacting method, thereby setting the second training condition. Detailed setting contents of the second training condition are as follows. An activation function type “ReLU”, an optimizer type “Adam (learning ratio α=0.01)”, an L2 regularization intensity “2. (weight decay)=1e-6, 1e-5, 1e-4, 1e-3, 1e-2”, an epoch number “100”, and a mini batch size “128” are set. The intensity of weight decay is a hyper parameter that adjusts the tradeoff between the inference accuracy (recognition ratio) and the model size. In this embodiment, the above-described five variations are set as the second training condition. If there is an abundant computer resource, training samples in the mini batch may be selected based on a plurality of random number seeds.

When step S2 is performed, the training unit 13 trains the second machine learning model (step S3). In step S3, in accordance with the second training condition set in step S2 and based on the training data acquired in step S1, the training unit 13 trains (iteratively trains) the learning parameters assigned to the model architecture of the first machine learning model acquired in step S1. The trained learning parameters are called second learning parameters. A machine learning model to which the second learning parameters are assigned is called a second machine learning model. More specifically, the model architecture (second model architecture) of the second machine learning model is a model architecture obtained by optimizing (compacting) the first model architecture in accordance with the values of the second learning parameters. Also, the training unit 13 calculates the second inference accuracy by applying evaluation data to the second machine learning model.

In step S3, one or more second machine learning models are trained in accordance with one or more second training conditions. In this embodiment, a plurality of second machine learning models are trained in accordance with a plurality of second training conditions.

Training of the machine learning model is represented by

yi=f(W,xi) (1)

Li=−ti^{T} ln(yi) (2)

Equation (1) represents an output yi of the machine learning model when a training sample xi is input. Here, f is the function of a machine learning model that holds a parameter set W, which repeats operations of the fully connected layer and the activation function and outputs a two-dimensional vector. Note that in this embodiment, the function f is the output after softmax processing, and in the output vector, all elements are non-negative, and the sum of the elements are normalized to 1. Equation (2) represents the formula of a training error Li of the training sample xi. The training error Li according to this embodiment is defined by the cross entropy of the target label ti and the output yi of the machine learning model.

The training unit 13 according to this embodiment repeats back propagation and stochastic gradient descent such that the training error calculated by the average of training errors of some training sample sets is minimized, thereby training the value of the parameter set W of the machine learning model. In step S3, the training unit 13 repeats back propagation and stochastic gradient descent to minimize the training error, thereby training the second learning parameters. The training unit 13 compacts the first model architecture (the second model architecture before compacting) in accordance with the trained second learning parameters, thereby calculating the second model architecture (the second model architecture after compacting).

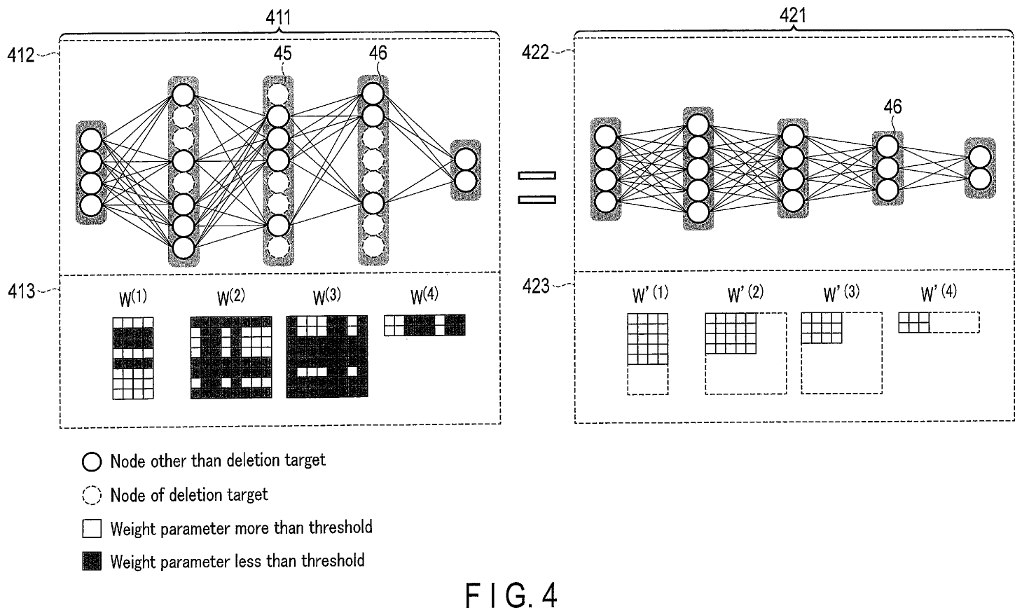

FIG. 4 is a view schematically showing second machine learning models 411 and 421 before and after compacting. The left view of FIG. 4 shows the second machine learning model 411 before compacting, and the right view of FIG. 4 shows the second machine learning model 421 after compacting. The second machine learning model 411 before compacting includes a second model architecture 412 and a learning parameter 413 before compacting. The second model architecture 412 equals the model architecture (first model architecture) of the first machine learning model. Referring to FIG. 4, the second learning parameter 413 shows only the parameter set W={W⁽¹⁾} (1=1, 2, 3, 4=L) having weight parameters, as in FIG. 3. If training is performed under the second training condition, weight parameters connected to some nodes converge to a small threshold or less, as shown in the left view of FIG. 4. The small threshold is set to, for example, 1e-6. Note that in FIG. 4, each white square in the squares representing second weight parameters shows a weight parameter having a value larger than the threshold, and each gray square shows a weight parameter having a value smaller than the threshold.

The training unit 13 compacts the second model architecture 412 in accordance with the values of the trained weight parameters. Compacting is executed by the technique described in US 2020/0012945. For example, the training unit 13 deletes a node 45 connected to a weight parameter smaller than the threshold from the nodes included in the second model architecture 412 before compacting, and leaves a node 46 connected to a weight parameter larger than the threshold. Accordingly, a second model architecture 422 after compacting is generated. All weight parameters of a second learning parameter 423 after compacting have values equal to or larger than the threshold. The second model architecture 422 to which the second learning parameter 423 after compacting is assigned forms the second machine learning model 421 after compacting.

The second machine learning model 421 is a compacted machine learning model that performs calculation equivalent to the first machine learning model. As the intensity of weight decay of the second training condition increases, the model size of the second model architecture 422 becomes smaller than that of the first model architecture, and the inference accuracy tends to lower (the recognition ratio lowers).

When step S3 is performed, the determination unit 14 determines whether to perform retraining (step S4). In step S4, the determination unit 14 determines, based on comparison between the first inference accuracy and the second inference accuracy, whether to perform retraining. As an example, if a plurality of second machine learning models are trained in step S3, the determination unit 14 determines, based on comparison between the best value in a plurality of second inference accuracies for a predetermined model size or less (to be referred to as a size reference value hereinafter) and a reference value (to be referred to as an accuracy reference value hereinafter) based on the first inference accuracy, whether to perform retraining. In other words, the determination unit 14 determines the necessity of retraining in accordance with a judgement criterion based on the size reference value and the accuracy reference value. The size reference value and the accuracy reference value are determined based on the performance or required specifications of the computer on which the machine learning model is mounted. More specifically, the size reference value is set using the model size of the first machine learning model as a reference, and typically, preferably set to the maximum value smaller than the model size of the first machine learning model, with which a demander can make a compromise. Alternatively, the size reference value may be set to a predetermined ratio of the model size of the first machine learning model or a value obtained by subtracting a predetermined value from the model size. Similarly, the accuracy reference value is set using the first inference accuracy as a reference, and typically, preferably set to the minimum value smaller than the first inference accuracy, which the demander satisfies. Alternatively, the accuracy reference value may be set to a predetermined ratio of the first inference accuracy or a value obtained by subtracting a predetermined value from the first inference accuracy.

More specifically, assume that the numbers of parameters of the second model architecture after compacting, which correspond to the L2 regularization intensities λ (weight decay)={1e-6, 1e-5, 1e-4, 1e-3, 1e-2} are {122, 110, 100, 82, 58}, and the second inference accuracies are {90%, 88%, 87%, 80%, 60%}. In addition, the size reference value is assumed to be 100, and the accuracy reference value is assumed to be 85%.

In this case, the inference accuracies of the second machine learning model for which the number of parameters of the second model architecture is 100 or less are {87%, 80%, 60%}. The best value of these is the largest value 87%. Since the best value=87% is larger (more excellent) than the accuracy reference value=85%, the judgement criterion is satisfied. It is therefore determined not to perform retraining (NO in step S4).

As another example, the size reference value is assumed to be 80, and the accuracy reference value is assumed to be 85%. In this case, based on the above-described judgement criterion, it is determined to perform retraining (YES in step S4). Note that in the above example, it is determined, based on comparison between the accuracy reference value and the best value in the plurality of second inference accuracies equal to or less than the size reference value, whether to perform retraining. However, this embodiment is not limited to this. For example, it may simply be determined, based on the magnitude relationship between a threshold and the difference value between the first inference accuracy and the best value, whether to perform retraining.

Upon determining to perform retraining (YES in step S4), the retraining unit 15 trains a third machine learning model (step S5). In step S5, the retraining unit 15 trains the third machine learning model based on a third model architecture and a third training condition.

In step S5, the retraining unit 15 sets the model architecture (third model architecture) of the third machine learning model based on the model architecture (second model architecture) of the second machine learning model. More specifically, the retraining unit 15 sets the third model architecture in accordance with the number of nodes, the number of channels, the number of layers, and the kernel size of the second model architecture and/or linear conversion of an input resolution, or the number of nodes, the number of channels, the number of layers, and the kernel size of the second model architecture and/or fraction processing of a multiple or a multiplier of a predetermined natural number of the input resolution. For example, according to reference technology 1 (Ariel Gordon et al., “MorphNet: Fast &amp; Simple Resource-Constrained Structure Learning of Deep Networks”, in CVPR2018), a model architecture obtained by deforming the second model architecture within a range equal to or smaller than the size reference value is used as the third model architecture. Here, “deform” means increasing/decreasing the number of nodes, the number of channels, or the like of the second model architecture equal to or less than the size reference value by a small amount. Alternatively, a model architecture that is deformed or is equal to the second model architecture having a model size larger than the size reference value by a small amount may be used as the third model architecture. Note that the third model architecture may be the same as the second model architecture after compacting.

In step S5, the retraining unit 15 calculates the third training condition based on the first training condition. The first training condition is an effective training condition examined before compacting, and is more excellent than the second training condition changed for compacting at a high possibility in terms of performance. For this reason, the third training condition is preferably set not to be the same as the second training condition but to be the same as the first training condition. As more advanced setting, for example, a training condition in which the learning ratio or the epoch number is decreased from the first training condition using a table or a formula according to the decrease amount (decrease ratio) of the model size may be set to the third training condition.

In step S5, in accordance with the third training condition set in the above-described way and based on the training data acquired in step S1, the retraining unit 15 trains (iteratively trains) a third learning parameter assigned to the third machine learning model, and generates a trained third machine learning model. The training of the third machine learning model is preferably performed by fine training or scratch training. Fine training is a method of setting some or all of the learning parameters of the trained second machine learning model to initial values and relearning all the learning parameters. Scratch training is a method of setting learning parameters initialized by a predetermined random number to initial values and relearning all the learning parameters. The initial values of the learning parameters may be set by a method in which fine training and scratch training are mixed. In accordance with these initial value setting methods, particularly the learning ratio in the third training condition may be changed. After retraining, the retraining unit 15 calculates a third inference accuracy by applying evaluation data to the trained third machine learning model.

Upon determining in step S4 that retraining is unnecessary (NO in step S4), or if step S5 is performed, the display control unit 16 displays the training result (step S6). The training result includes the model architecture, the model size, and the inference accuracy of each machine learning model. The training result is displayed in a predetermined layout on the display device 5.

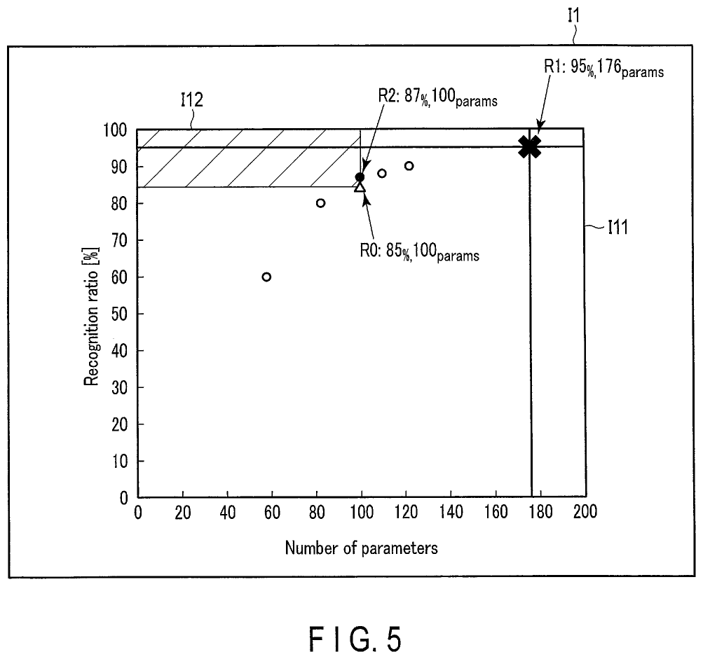

FIG. 5 is a view showing an example of a display screen I1 of a training result when it is determined in step S4 that retraining is unnecessary. As shown in FIG. 5, a graph I11 in which the ordinate represents the recognition ratio [%], and the abscissa represents the number of parameters is displayed as a training result on a display screen I1. Note that the recognition ratio is an example of the inference accuracy, and the number of parameters is an example of the model size. A plurality of points corresponding to the plurality of second machine learning models trained in step S3 are plotted on the graph I11. Also, a point corresponding to the first machine learning model is also preferably plotted on the graph I11. Each point represents the display screen and the model size of a machine learning model. The points corresponding to the second machine learning models and the point corresponding to the first machine learning model are preferably are preferably displayed in different shapes, sizes, and/or colors. For example, in FIG. 5, five points corresponding to the second machine learning models are drawn as full circles, and the point corresponding to the first machine learning model is drawn as a cross mark. In addition, a thick line representing the inference accuracy of the first machine learning model and a thick line representing the model size are superimposed on the graph I11 such that these cross the point. When the inference accuracies and the model sizes of the first machine learning model and the second machine learning models are displayed on the graph in this way, it is possible to visually clearly grasp the relationship between these and also easily specify a machine learning model having a desired inference accuracy and model size.

On the graph I11, a point corresponding to a judgement criterion R0 for retraining in step S4 is displayed. In FIG. 5, this point is displayed as a triangle. Referring to FIG. 5, the judgement criterion R0 represents a size reference value=100 and a recognition ratio=85%, as in the above-described example. In addition, a region I12 that satisfies the judgement criterion R0 is preferably visually enhanced by red or the like and displayed on the graph I11. Of the plurality of points corresponding to the second machine learning models, a point included in the region I12, that is, a point that satisfies the judgement criterion for retraining is preferably displayed in a shape, size, and/or color different from a point that does not satisfy. As an example, a point included in the region I12 is preferably displayed in red, and a point that is not included in the region I12 is preferably displayed in black. When a point corresponding to the judgement criterion and a region that satisfies the judgement criterion are displayed on the graph I11 in this way, it is possible to visually easily judge whether each machine learning model satisfies the judgement criterion.

As shown in FIG. 5, for a point corresponding to each machine learning model, numerical values describing the inference accuracy and the model size of the machine learning model corresponding to the point are preferably displayed visually in association with the point. For a point corresponding to a second machine learning model R2, numerical values representing the inference accuracy and the number of parameters may be displayed only for a point that satisfies the judgement criterion R0. For example, as shown in FIG. 5, “R2:87%, 100ₚₐᵣₐₘₛ” is displayed in association with the point of the second machine learning model R2 included in the region I12. Numerical values may be displayed for all points corresponding to the second machine learning model R2, as a matter of course, or numerical values may be displayed only for a point designated via the input device 3 or the like. Also, “R0:85%, 100ₚₐᵣₐₘₛ” may be displayed in association with a point corresponding to the judgement criterion R0, and “R1:95%, 176ₚₐᵣₐₘₛ” may be displayed in association with a point corresponding to the first machine learning model R1.

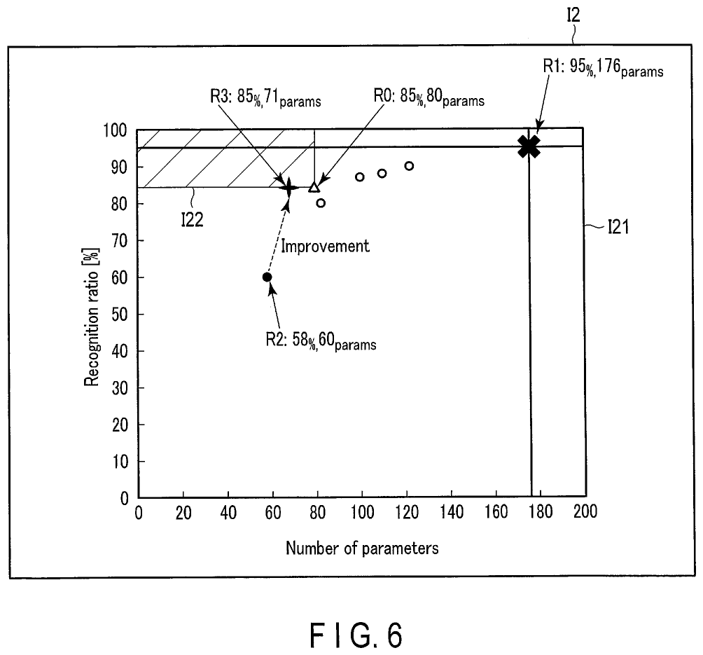

FIG. 6 is a view showing an example of a display screen I2 of a training result when it is determined in step S4 that retraining is necessary. As shown in FIG. 6, a graph I21 in which the ordinate represents the recognition ratio [%], and the abscissa represents the number of parameters is displayed as a training result on the display screen I2, as in FIG. 5. A plurality of points corresponding to the plurality of second machine learning models R2 trained in step S3, a point corresponding to the first machine learning model R1, and a point corresponding to a third machine learning model R3 are plotted on the graph I21. Each point represents the inference accuracy and the model size of a machine learning model. In addition, a point corresponding to the judgement criterion R0 and a region I22 that satisfies the judgement criterion are displayed on the graph I21, like the graph I11. The points corresponding to the second machine learning models R2, the point corresponding to the first machine learning model R1, and the point corresponding to the third machine learning model R3 are preferably displayed in different shapes, sizes, and/or colors. When the inference accuracies and the model sizes of the first machine learning model, the second machine learning models R2, and the third machine learning model R3 are displayed on the graph in this way, it is possible to visually clearly grasp the relationship between these and also easily specify a machine learning model having a desired inference accuracy and model size. For example, according to FIG. 6, it is possible to easily grasp that the inference accuracy (recognition ratio) of the third machine learning model R3 is improved by retraining as compared to the best value of the second machine learning model R2, and the degree of improvement.

As shown in FIG. 6, of the plurality of points corresponding to the second machine learning models R2, a point which satisfies the reference of the model size and whose inference accuracy has the best value is preferably visually enhanced by blue or the like. As in FIG. 5, for each point corresponding to a machine learning model, numerical values describing the inference accuracy and the model size of the machine learning model corresponding to the point are preferably displayed visually in association with the point. At this time, the numerical values describing the inference accuracy and the model size are preferably displayed with visual discrimination between values that satisfy the judgement criterion R0 and values that do not satisfy. For example, numerical values that represent an inference accuracy and a model size and satisfy the judgement criterion R0 are preferably displayed in red, and numerical values that do not satisfy the judgement criterion R0 are preferably displayed in blue.

The display control unit 16 may display the architectures of the first machine learning model, the second machine learning model, and/or the third machine learning model on the display device 5. As an example, if a point corresponding to the first machine learning model, the second machine learning models, and/or the third machine learning model, which are displayed on the graph I11 or I21 in FIG. 5 or 6, is designated via the input device 3, the display control unit 16 displays the architecture of the machine learning model corresponding to the designated point.

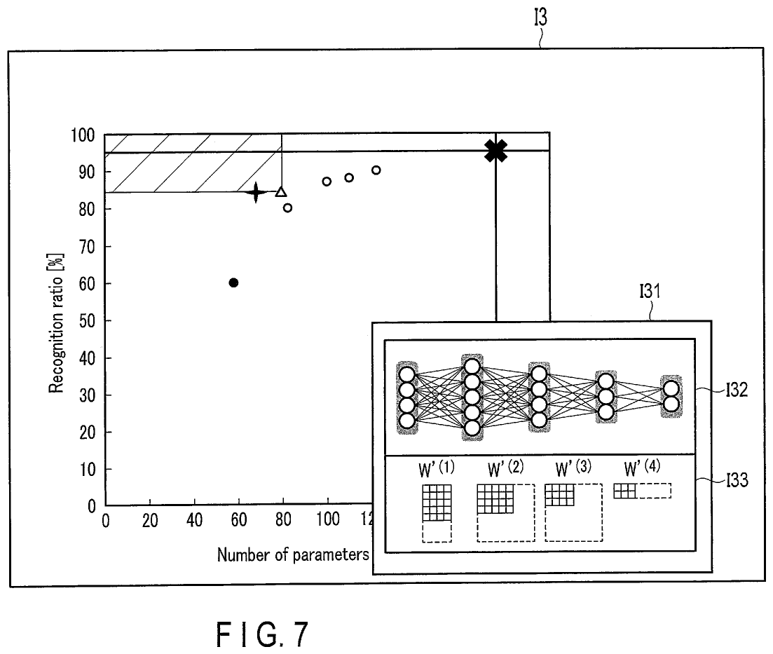

FIG. 7 is a view showing an example of a display screen I3 of the architecture of a machine learning model. As shown in FIG. 7, if a point corresponding to the second machine learning model R2 is designated via the input device 3, the display control unit 16 displays the architecture of the second machine learning model R2. More specifically, if a point corresponding to the second machine learning model is designated via the input device 3, the display control unit 16 displays a display window I31. The display window I31 displays a schematic view I32 of the model architecture of the designated second machine learning model R2 and a schematic view I33 of weight parameters. In the schematic view I32, layers and nodes included in the layers are drawn such that the number of layers and the number of nodes of the second machine learning model R2 can visually be recognized. In the schematic view I33, squares representing the weight parameters are drawn such that the number of weight parameters of a parameter set W′⁽¹⁾ between layers can visually be recognized. A dotted line or the like representing the number of elements of the weight parameters before compacting may be drawn.

The operator confirms the training results shown in FIGS. 5 to 7, and selects the second machine learning model or the third machine learning model having desired performance. For example, if it is determined that retraining is unnecessary, the second machine learning model that satisfies the judgement criterion is selected. If retraining is executed, the third machine learning model is selected. The selected second machine learning model or third machine learning model is preferably stored in the storage device 2 or a portable storage medium or transferred to the computer of the demander via the communication device 4.

When step S6 is performed, the training processing shown in FIG. 2 is ended.

According to the above-described training processing, performance before compacting and that after compacting are compared, and necessity of retraining is automatically determined. If the performance satisfies the judgement criterion without lowering after compacting, the second machine learning model generated by compacting is employed. If the performance does not satisfy the judgement criterion, retraining is executed, and the third machine learning model generated by retraining is employed. According to this training process, it is possible to efficiently search for a machine learning model having satisfactory performance with good balance between the model size and the inference accuracy.

Note that this embodiment is not limited to the above-described embodiment, and changes and modifications can be made without departing from the scope of the present invention.

(Modification 1)

In the above-described embodiment, the task of the machine learning model is image classification. However, the embodiment is not limited to this. As an example, the task according to this embodiment can also be applied to semantic segmentation, object detection, a generation model, and the like. In addition, the input to the machine learning model is not limited to image data. For example, if the input is text data, the task may be machine translation. As another example, if the input to the machine learning model is voice data, the task may be voice recognition.

(Modification 2)

In the above-described embodiment, the model architecture of the machine learning model is an MLP (Multilayer Perceptron). However, the embodiment is not limited to this. The model architecture according to this embodiment can be applied to any model architecture such as a CNN, an RNN (Recurrent Neural Network), or an LSTM (Long Short-Term Memory).

(Modification 3)

In the above-described embodiment, the acquisition unit 11 acquires the first machine learning model and the first inference accuracy, which are already calculated, from another computer or the like. However, the embodiment is not limited to this. As an example, the processing circuit 1 may train the first machine learning model based on the training data, the model architecture of the first machine learning model, and the first training condition. In this case, the processing circuit 1 preferably calculate the first inference accuracy by applying evaluation data to the already trained first machine learning model.

(Modification 4)

As the second training condition, the setting unit 12 according to Modification 4 sets the optimization method to Adam, introduces L2 regularization, and sets the activation function to a saturation nonlinear function, different from the first training condition. For example, if compacting is executed using the technique described in US 2020/0012945, the activation function is preferably set to a saturation nonlinear function other than ReLU. The setting unit 12 may select, as the activation function concerning the second training condition, a saturation nonlinear function whose behavior is closest to that of the activation function set in the first training condition from a table (LUT: Look Up Table). As an example, if the activation function concerning the first training condition is a sigmoid function, a hard sigmoid function is preferably selected as the activation function concerning the second training condition.

If compacting is executed using a technique other than the technique described in US 2020/0012945, the setting unit 12 preferably sets the second training condition in accordance with the characteristic of the compacting. As an example, in a compacting method according to reference technology 2 (Jianhui Yu et al., “Slimmable Neural Networks”, ICLR2019), L1 regularization is introduced to a BN (Batch Normalization) layer, thereby pruning channels of unnecessary hidden layers after training. In this case, concerning the second training condition, the setting unit 12 adds a BN layer, and introduces L1 regularization to the BN layer. It is preferable to set a plurality of L1 regularization intensities.

(Modification 5)

In the above-described embodiment, from the viewpoint of efficient training of the machine learning model, the retraining unit 15 executes retraining only for one second machine learning model selected based on the size reference value and the accuracy reference value. However, if an abundant computer resource is usable, the retraining unit 15 may execute retraining for all second machine learning models. In this case, a final third machine learning model is preferably selected from a plurality of third machine learning models based on the size reference value and the accuracy reference value. In Modification 5, since retraining is performed for all second machine learning models, the determination unit 14 is unnecessary.

(Modification 6)

In the embodiment shown in FIG. 2, if it is determined, in step S4, not to perform retraining (NO in step S4), or if step S5 is performed, the display control unit 16 displays the training result in step S6. However, the embodiment is not limited to this. As an example, when executing step S4, the display control unit 16 may display the first inference accuracy, the second inference accuracy, the size reference value, and the accuracy reference value. After that, the retraining unit 15 may correct the judgement criterion defined by the size reference value and the accuracy reference value and execute training of the third machine learning model and calculation of the third inference accuracy after that (step S5), and the display control unit 16 may display the training result (step S6).

### Additional Remarks

According to several embodiments described above, the learning apparatus 100 includes the acquisition unit 11, the setting unit 12, the training unit 13, and the retraining unit 15. The acquisition unit 11 acquires the first training condition and the first machine learning model trained in accordance with the first training condition. The setting unit 12 sets the second training condition used to reduce the model size of the first machine learning model, different from the first training condition. In accordance with the second training condition and based on the first machine learning model, the training unit 13 trains the second machine learning model whose model size is smaller than that of the first machine learning model. In accordance with the third training condition that is not the same as the second training condition and complies with the first training condition, the retraining unit 15 trains the third machine learning model based on the second machine learning model.

Hence, according to this embodiment, desired performance concerning a machine learning model can easily be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning apparatus comprising a processing circuit configured to
acquire a first training condition and a first machine learning model trained in accordance with the first training condition,
set a second training condition used to reduce a model size of the first machine learning model, different from the first training condition,
in accordance with the second training condition and based on the first machine learning model, train a second machine learning model whose model size is smaller than that of the first machine learning model, and
in accordance with a third training condition that is not the same as the second training condition and complies with the first training condition, train a third machine learning model based on the second machine learning model.

2. The apparatus according to claim 1, wherein the processing circuit
determines necessity of training of the third machine learning model based on comparison between a first inference accuracy representing accuracy of inference concerning the first machine learning model and a second inference accuracy representing accuracy of inference concerning the second machine learning model, and
upon determining that training of the third machine learning model is necessary, trains the third machine learning model.

3. The apparatus according to claim 2, wherein the processing circuit
sets a plurality of second training conditions different from each other,
trains a plurality of second machine learning models in accordance with the plurality of second training conditions, and
determines the necessity of the third machine learning model based on comparison between a best value in second inference accuracies corresponding to the second machine learning models each having a model size not less than a reference value in the plurality of second machine learning models and the reference value based on the first inference accuracy.

4. The apparatus according to claim 1, wherein the processing circuit sets the third machine learning model in accordance with the number of nodes, the number of channels, the number of layers, and a kernel size of the second machine learning model and/or linear conversion of an input resolution, or the number of nodes, the number of channels, the number of layers, and the kernel size of the second machine learning model and/or fraction processing of one of a multiple and a multiplier of a predetermined natural number of the input resolution.

5. The apparatus according to claim 1, wherein the processing circuit initializes a learning parameter of the third machine learning model in accordance with a predetermined random number, or initializes the learning parameter by copying some trained weight coefficients of the second machine learning model.

6. The apparatus according to claim 1, wherein as the second training condition, the processing circuit sets an optimization method to Adam, introduces L2 regularization, and sets an activation function to a saturation nonlinear function, different from the first training condition.

7. The apparatus according to claim 1, wherein as the second training condition, the processing circuit adds a BN layer and introduces L1 regularization to the BN layer, different from the first training condition.

8. The apparatus according to claim 1, wherein the processing circuit displays, on a display device, architectures of the first machine learning model, the second machine learning model, and/or the third machine learning model.

9. The apparatus according to claim 1, wherein the processing circuit displays, on a display device, the model sizes of the first machine learning model, the second machine learning model, and/or the third machine learning model.

10. The apparatus according to claim 1, wherein the processing circuit displays, on a display device, performance of the first machine learning model, the second machine learning model, and/or the third machine learning model.

11. The apparatus according to claim 3, wherein the processing circuit displays, on a display device, a graph that plots a plurality of points representing the inference accuracies and the model sizes of the plurality of second machine learning models.

12. The apparatus according to claim 11, wherein the processing circuit displays, on the graph, a point corresponding to the reference value and the best value and/or a region that satisfies the reference value and the best value.

13. The apparatus according to claim 12, wherein of the plurality of points, the processing circuit displays a point that is included in the region and a point that is not included in the region in different colors.

14. The apparatus according to claim 11, wherein the processing circuit plots, on the graph, a point representing the inference accuracy and the model size of the third machine learning model.

15. The apparatus according to claim 14, wherein the processing circuit displays a plurality of points corresponding to the plurality of second machine learning models and a point corresponding to the third machine learning model in different shapes, sizes, and/or colors.

16. A learning method comprising:
acquiring a first training condition and a first machine learning model trained in accordance with the first training condition;
setting a second training condition used to reduce a model size of the first machine learning model, different from the first training condition;
in accordance with the second training condition and based on the first machine learning model, training a second machine learning model whose model size is smaller than that of the first machine learning model; and
in accordance with a third training condition that is not the same as the second training condition and complies with the first training condition, training a third machine learning model based on the second machine learning model.

17. A non-transitory computer readable storage medium including computer executable instructions, wherein the instructions, when executed by a processor, cause the processor to perform operations comprising:
acquiring a first training condition and a first machine learning model trained in accordance with the first training condition;
setting a second training condition used to reduce a model size of the first machine learning model, different from the first training condition;
in accordance with the second training condition and based on the first machine learning model, training a second machine learning model whose model size is smaller than that of the first machine learning model; and
in accordance with a third training condition that is not the same as the second training condition and complies with the first training condition, training a third machine learning model based on the second machine learning model.
